(19) United States
(12) Patent Application Publication
(10) Pub. No.: US 2007/0172341 A1
(43) Pub. Date: Jul. 26, 2007

(54) Container driver

(76) Inventor: Lawrence Gregory, West Covina, CA (US)

Correspondence Address: CROCKETT & CROCKETT, 24012 CALLE DE LA PLATA, SUITE 400, LAGUNA HILLS, CA, 92653, US

(21) Appl. No.: 11/713,310

(22) Filed: Mar. 1, 2007

Related U.S. Application Data
(63) Continuation-in-part of application No. 11/191,551, filed on Jul. 28, 2005.
(60) Provisional application No. 60/592,985, filed on Jul. 29, 2004.

(51) Int. Cl. B60P 1/02

(52) U.S. Cl. 414/495

(57) ABSTRACT

A container transportation assist vehicle (CTAV) according to the present invention may include an assist vehicle having an electric control to enable a user to engage the pilot vehicle to a refuse bin or other suitable container and use the motor or motors of the pilot vehicle to propel and steer the refuse bin or other container to a selected area. Alternatively, the CTAV may be steered manually, or using a handle, or using a handle coupled with a pivotable wheel. The CTAV further comprises a lifting platform to transfer refuse bin weight to the CTAV for traction, and an attachment means to fixedly engage the refuse bin.

### RELATED APPLICATIONS

This application is a continuation-in-part of co-pending U.S. application Ser. No. 11/191,551, filed Jul. 28, 2005, which claims priority to U.S. Provisional Patent Application 60/592,985, filed Jul. 29, 2004.

### FIELD OF THE INVENTION

This invention relates to refuse management systems, and more specifically to remotely controlled, refuse container pilot vehicles.

### BACKGROUND OF THE INVENTION

Refuse management and disposal often requires that refuse bins ranging in size from 11/2, 2, 3, and 4 cubic yards be moved, sometimes up hills, for collection. Refuse bins are often stored at locations convenient for the users, and sometimes at locations that are secluded from public view. Many times, such locations are not readily accessible by vehicles used to collect refuse from the bins, and the refuse bins must be moved so that they are accessible to refuse collection vehicles. Conventional practice is to manually move the loaded bins to an area for collection, and the weight of a loaded refuse bin may be beyond the capability of a single operator to move. In some cases an ancillary vehicle such as a pickup truck equipped with apparatus to enable loaded refuse bins to be moved is required to move refuse bins to an area for collection. However, an ancillary vehicle requires an additional operator, and such an ancillary vehicle may not be available in a timely manner when a refuse bin must be moved for access. Therefore, what is needed is a small, electric pilot vehicle, operable by a single individual, to move loaded refuse bins.

### SUMMARY

The present invention provides a container transportation assist vehicle (CTAV) having a remote control thereby enabling a user to couple the assist vehicle with a refuse bin or other suitable container and use the pilot vehicle propulsion system to propel and steer the refuse bin or other container to a selected area.

A refuse bin is a standardized metal container generally in shape of an open rectangular prism and typically having four steel casters, or alternatively two fixed wheels and two casters. The casters or wheels allow a clearance of 8½ inches between the bottom of the refuse bin and the surface upon which it rests. In addition, the refuse bin may have two integral channels, one on each side, to engage with the lifting mechanism of the refuse collection vehicle. An operator positions a CTAV underneath the bin in the space between the bottom of the bin and the surface upon which the bin rests (the space defined by the caster or wheel height). A mechanism on the CTAV raises a lifting platform to engage the bottom of the refuse bin thereby transferring a portion of the bin's weight to the CTAV. Once a portion of the bin's weight is transferred to the CTAV, the CTAV further engages the refuse bin using mechanical, electromagnetic, or suction means. Having thusly engaged the refuse bin, the operator may then activate the pilot's propulsion system to move the refuse bin to another location.

The CTAV propulsion system may comprise at least one electric motor coupled to drive mechanisms, such as wheels or continuous tracks, positioned on each side of the CTAV. Each drive mechanism may be coupled to an independent motor allowing each drive mechanism to be operated independently from the other thereby allowing differential movement of the drive mechanisms. Such differential movement will cause a change in the direction of travel of the CTAV. Alternatively, a handle connected to a pivotable wheel may provide steering.

The drive mechanisms may be articulated or suspended thereby allowing the CTAV to traverse obstacles such as changes in surface elevation, curbs, potholes and the like.

The CTAV may be secured to the refuse bin using one or more electromagnets. One or more electromagnets may be integral with the lifting platform, and when energized, couple the front of the refuse bin to the lifting platform. When the one or more electromagnets are energized, the CTAV is attached to the refuse bin on at least one surface of the bin.

Alternatively, the CTAV may attach to the refuse bin on one or more surfaces using suction devices, mechanical connections, mechanical interferences or any other means. Any means of attaching the CTAV to the refuse bin must have sufficient strength to attach securely and to allow the CTAV to transport a fully loaded bin. In addition to the attachment devices, the CTAV may include one or more stabilizer arms to enhance the stability and control of the CTAV over the refuse bin.

The present invention also includes a remote controller having controls for the one or more drive mechanism as well as controls to enable/disable the engagement device, and to extend and retract the lifting platform. The remote controller may also include one or more displays for such information as battery status, and engagement device status.

The CTAV includes at least one rechargeable electric battery for providing power to the CTAV propulsion system, magnetic attachment devices, lifting platform actuation mechanism, and the controls. A recharging system may be internal or external to the CTAV. An internal recharging system will receive electrical energy in a convenient form from an external source such as 120 volts ac or 12 volts dc, convert the external voltage to the internal battery voltages, and control the charging currents. The at least one rechargeable electric battery may be of any type and capacity suitable for the expected CTAV use. An external recharging system would accept electrical energy in a convenient form and provide at least one nominal dc voltage to the at least one rechargeable battery typically through at one or more plug connections.

The present invention also may include a self lifting carrying rack for a CTAV. The carrying rack may be fitted on a refuse collection truck or other suitable vehicle. A carrying rack may be further fitted with one or more power connectors which may mate with one or more external connections to the CTAV thereby enabling the at least one rechargeable battery to be recharged by the carrying vehicle.

A container transportation assist vehicle (CTAV) according to the present invention may include an assist vehicle having an electric control to enable a user to engage the pilot vehicle to a refuse bin or other suitable container and use the motor or motors of the pilot vehicle to propel and steer the refuse bin or other container to a selected area. Alternatively, the CTAV may be steered manually, or using a handle, or using a handle coupled with a pivotable wheel. The CTAV further comprises a lifting platform to transfer refuse bin weight to the CTAV for traction, and an attachment means to fixedly engage the refuse bin.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a side view of a CTAV engaging a refuse bin according to the present disclosure.

FIG. 2 is a block diagram of one embodiment of the CTAV of FIG. 1.

FIG. 3 is a block diagram of another embodiment of a CTAV according to the present invention.

FIG. 4 is s side view of a container driver engaging the rim of a container to be moved.

FIG. 5 is a side view of a container driver transferring the weight of a container to be moved.

FIG. 6 is a perspective of a container driver and cover with the cover removed.

FIG. 7 is a perspective view of a container driver with the engagement hooks extended.

FIG. 8 is a perspective view of the back of a container driver with the weight transfer paddle fully raised.

### DETAILED DESCRIPTION OF THE INVENTIONS

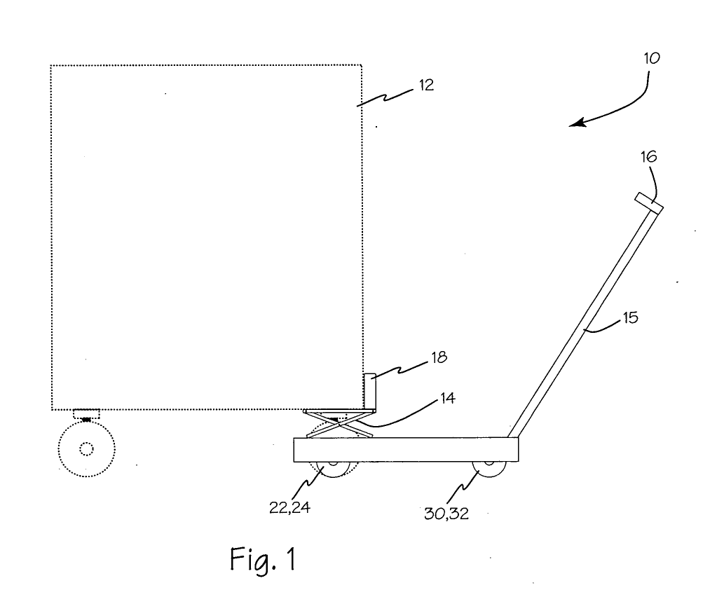

Referring now to FIG. 1, CTAV 10 may engage bin 12 and may be used to move and control bin 12. Lifting platform 14 may be used to engage CTAV 10 to bin 12. The lifting platform 14 is raised until it engages the bottom of the refuse bin 12, and exerts an upward force until a portion of the weight of the refuse bin is transferred to the CTAV 10. The weight transfer ensures that the CTAV 10 has sufficient traction to move the refuse bin 12. Lifting platform 14 may be raised and lowered using any suitable technique. Once the lifting platform 14 has been raised and a portion of the refuse bin 12 weight has been transferred, an attachment mechanism 18 is engaged to secure the refuse bin 12 to the CTAV 10. A portion of the refuse bin 12 weight has now been transferred to the drive wheels 22 and 24 and pivotable wheels or castors 30 and 32. Remote control 16 may be used to control lifting platform 14 as well as the motion and direction of CTAV 10.

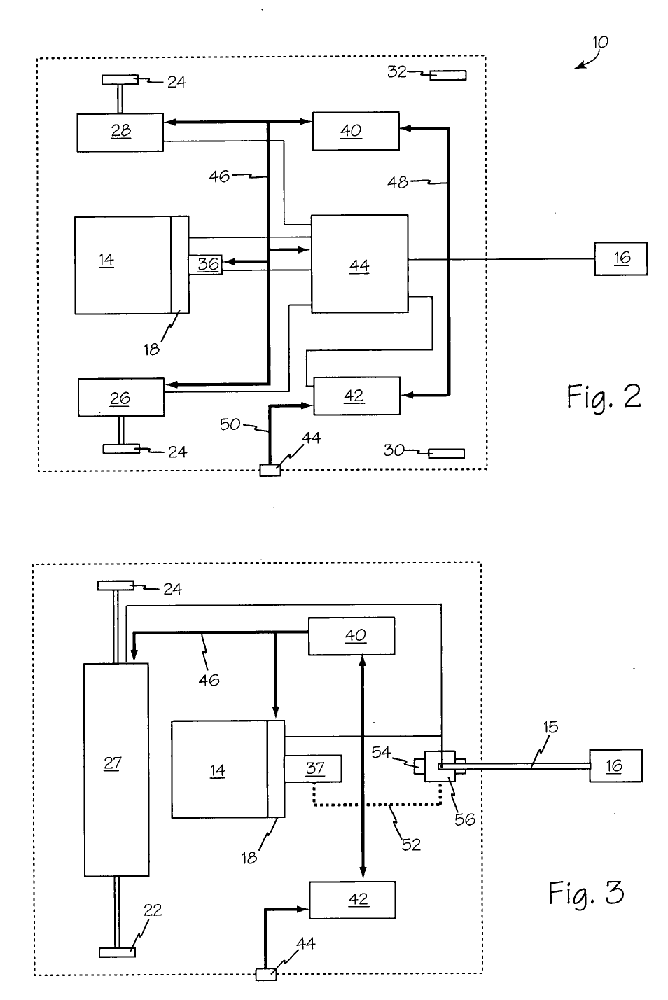

Referring now to FIG. 2, one embodiment of a CTAV 10 is shown. A CTAV 10 may include drive wheels 22 and 24 coupled to drive motors 26 and 28 respectively. The drive wheels 22 and 24 may be coupled to the motors 26 and 28 using any suitable means such as direct drive, gear drive, drive chains or belts, or any other means available to a skilled artisan in the field. Additional pivotable wheels or casters 30 and 32 may be provided for stability and also for allowing differential rotation of drive wheels 22 and 24 to steer the CTAV 10.

Alternative drive systems are contemplated including replacing the drive wheel and caster on each side by a caterpillar type track, and having the differential rotation of each caterpillar track provide steering. Other drive systems within the scope of this invention include multiple drive wheels on each side, or a CTAV 10 having a single drive wheel.

The CTAV 10 of FIG. 2 further comprises a lifting platform 14 that raises and lowers to engage a refuse bin 12, also shown in FIG. 1. The lifting platform 14 may be operated by actuator 36, and the lifting platform mechanism may comprise one or more of any convenient type such as a motor operated scissor jack, electrically or manually operated hydraulic jack, or a screw jack. If electrically operated, the actuator 36 may include feedback to limit the amount of weight transferred from the refuse bin 12 to the CTAV 10.

Attachment mechanism 18 is mounted on the lifting platform 14 for attaching to at least one surface of the refuse bin 12. The attachment mechanism 18 may be an electromagnet, suction or vacuum device, a mechanical connection, or any other attachment mechanism known to a skilled practitioner of the art. The attachment mechanism 18 must have sufficient strength to allow the CTAV 10 to transport a fully loaded refuse bin 12 up a contemplated grade.

Electric motors 26 and 28 receive power from at least one rechargeable battery 40 to propel the drive wheels 22 and 24. The battery 40 is a suitable size and type for the CTAV 10 to operate for a specified duty cycle. A skilled practitioner of the art may determine the battery type, battery voltage, and battery size to optimize cost, weight, and performance.

The CTAV 10 further comprises a battery charger 42 to provide recharging current to the at least one battery 40. Connector 44 is provided to receive external power in a convenient form to supply the battery charger 42. Depending upon a particular application, the external power may be 110/240 vac from an external source or may be 12 vdc from a support vehicle (not shown). It is further contemplated, in another embodiment, that the battery charger 42 may be external to the CTAV 10, in which case the output of the battery charger will be supplied directly to the at least one battery 40. The battery charger 42 may provide the appropriate charging current regulation for the type of battery being charged.

A user controls the operation of the CTAV 10 with a remote controller 16 located at the end of a control handle 15 (see FIG. 1) to provide speed and direction controls for each drive motor 26 and 28, to deactivate each drive motor 26 and 28, to set a safety brake (not shown), to actuate the lifting platform 18, and to actuate the attachment device 38. The remote control 44 also may have status indicators showing remaining battery life and operational status. Further, the remote controller 16 may have a safety switch, which when released, will deactivate the drive motors 26 and 28 and set a safety brake.

In one embodiment of the present invention, control handle 15 is contiguous and inflexible to provide tactile feedback to a user holding remote controller 16. In other embodiments of the present invention, remote controller 16 may connect to CTAV 10 using any suitable technique including but not limited to flexible cable, wireless RF and infrared.

Referring again to FIG. 2, at least one battery provides electrical power to the elements of CTAV 10 through power bus 46. Connector 44 may provide source power to the battery charger 42 via the battery charger bus 50, which provides charging current to the at least one battery 40 over the charging bus 48. Alternatively, if the battery charger 42 is external to the CTAV 10, connector 44 is connected to the at least one battery 40 using the charging bus 48.

Control signals may be produced by controller 44 in response to the remote controller 16 and distributed to the CTAV components. Alternatively, control signals may originate in remote controller 16 and are transmitted directly to the appropriate element of CTAV 10.

Referring now to FIG. 3, another embodiment of CTAV 10 is shown. Drive wheels 22 and 24 are coupled with a drive motor 27 using any suitable means such as direct drives, gear drives, chains, or belts. The drive wheels 22 and 24 are coupled to the drive motor 27 in such a manner that both drive wheels 22 and 24 rotate in the same direction and at the same speed.

A steerable wheel 54 is provided to control the direction of the CTAV 10 travel. The steerable wheel 54 is coupled to the control handle 15 which is moveable in a left or right direction, thereby steering the CTAV 10.

A lifting platform 14 is also provided to transfer a portion of the refuse bin 12 (see FIG. 1) weight to the CTAV 10. The lifting platform 14 further comprises one or more lifting mechanisms operated by an actuator 37 of a convenient type such as an hydraulic or scissors jack. As shown in FIG. 3, actuator 37 is hydraulically operated by the control handle 15, which is coupled with the hydraulic pump 56. The control handle 15 articulated in such a way to operate hydraulic pump 56 to increase and decrease the hydraulic pressure in the hydraulic line 52 and in the actuator 37. The foregoing is intended to describe only one method to operate the lifting platform 14 and does not limit the use of other methods for operating the lifting platform 14.

Attachment mechanism 18 is mounted on the lifting platform 14 for attaching to at least one surface of the refuse bin 12. The attachment mechanism 18 may be an electromagnet, a suction or vacuum device, a mechanical connection, or any other attachment mechanism known to a skilled practitioner of the art. The attachment mechanism 18 must have sufficient strength to allow the CTAV 10 to transport a fully loaded refuse bin 12 up a contemplated grade.

Electric motor 27 receives power from at least one rechargeable battery 40 to propel the drive wheels 22 and 24. The battery 40 is a suitable size and type for the CTAV 10 to operate for a specified duty cycle. A skilled practitioner of the art may determine the battery type, battery voltage, and battery size to optimize cost, weight, and performance.

The CTAV 10 further comprises a battery charger 42 to provide recharging current to the at least one battery 40. Connector 44 is provided to receive external power in a convenient form to supply the battery charger 42. Depending upon a particular application, the external power may be 110/240 vac from an external source or may be 12 vdc from a support vehicle (not shown). It is further contemplated, in yet another embodiment, that the battery charger 42 may be external to the CTAV 10, in which case the output of the battery charger will be supplied directly to the at least one battery 40. The battery charger 42 may provide the appropriate charging current regulation for the type of battery being charged.

A user controls the operation of this embodiment of the CTAV 10 with a remote controller 16 located at the end of a control handle 15 to provide speed and direction controls for the drive motor 27, to deactivate the drive motor 27, to set a safety brake (not shown), and to actuate the attachment device 18. The remote controller 44 also may have status indicators showing remaining battery life and operational status. Further, the remote controller 16 may have a safety switch, which when released, will deactivate the drive motor 27 and set a safety brake. Manipulating the control handle 15 steers the CTAV 10 and operates the lifting platform 14.

The at least one battery 40 provides electrical power to the elements of CTAV 10 through power bus 46. Connector 44 may provide source power to the battery charger 42 via the battery charger bus 50, which provides charging current to the at least one battery 40 over the charging bus 48. Alternatively, if the battery charger 42 is external to the CTAV 10, connector 44 is connected directly to the charging bus 48 for providing charging current to the at least one battery 40.

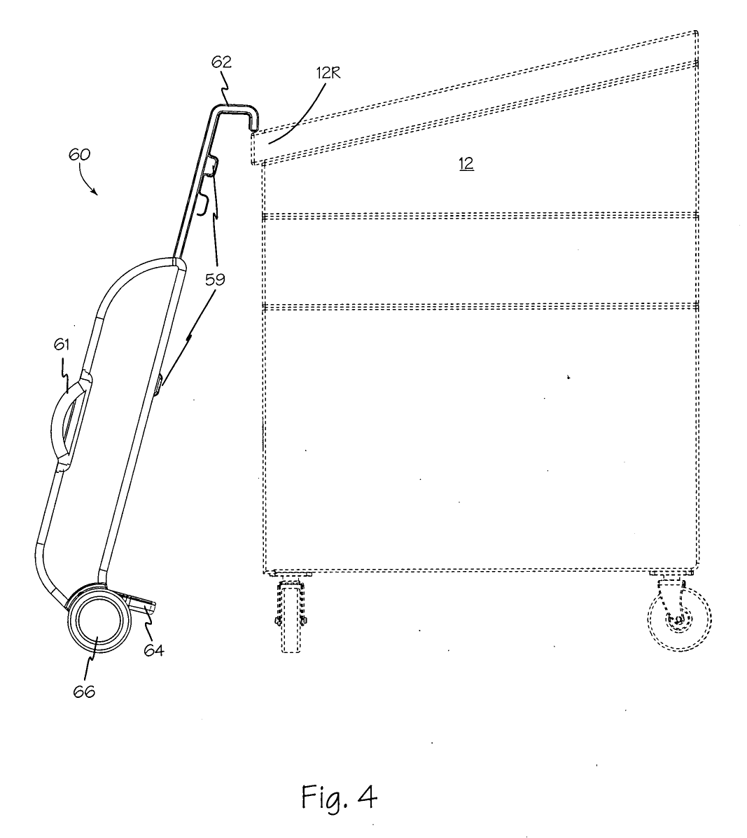

Alternatively, a container driver configured similar to a hand truck may engage any suitable container from the side. The container may be metal or plastic. Container driver 60 of FIG. 4 engages container 12 using one or more hooks 62 to secure rim 12R and weight transfer paddle 64 to transfer some of the weight of container 12 to wheels 66 to provide traction and motive energy. A single operator may control the drive mechanism of container driver 60 and direct the movement of container driver 60 and attached container 12. Additional handles such as handles 61 may be used for moving container driver 60 alone, or for additional control when attached to a container. One or more spacers or pads 59 may be provided to maintain a pre-selected distance between container driver 60 and container 12 and prevent mutual abrasion or defacement. The one or more spacers or pads such as pad 59 may further secure hooks 62 over rim 12R by occupying the void between the container driver 60 and the container 12 created by rim 12R.

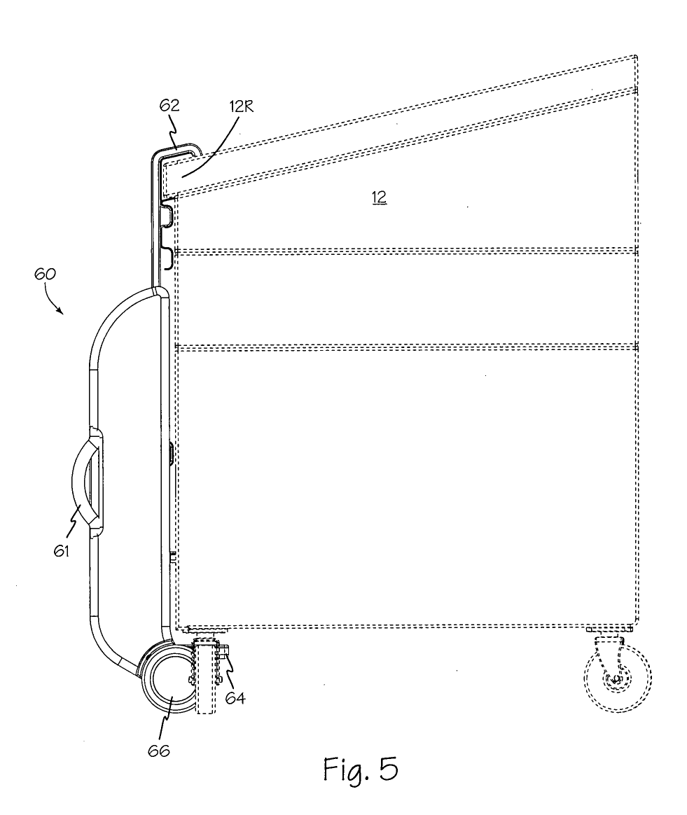

Referring now to FIG. 5, hooks 62 are extended and container driver 60 is adjacent to container 12 with weight transfer paddle 62 ready to raise and transfer weight from container 12 to provide suitable traction to the container driver to permit complete control of the container over sloped and uneven terrain. Hooks 62 may be freely extended from container driver 60 or they may be extended and retracted using any suitable drive mechanism. With the hook or hooks driven, container driver 60 may extend the hooks and raise itself to or into an support vehicle for transport to and from various locations for use. Hooks 62 may extend to a predefined limit to accommodate the various sizes of refuse containers. The limit of hook extension may be controlled by any suitable mechanism such as a manual lock or pin.

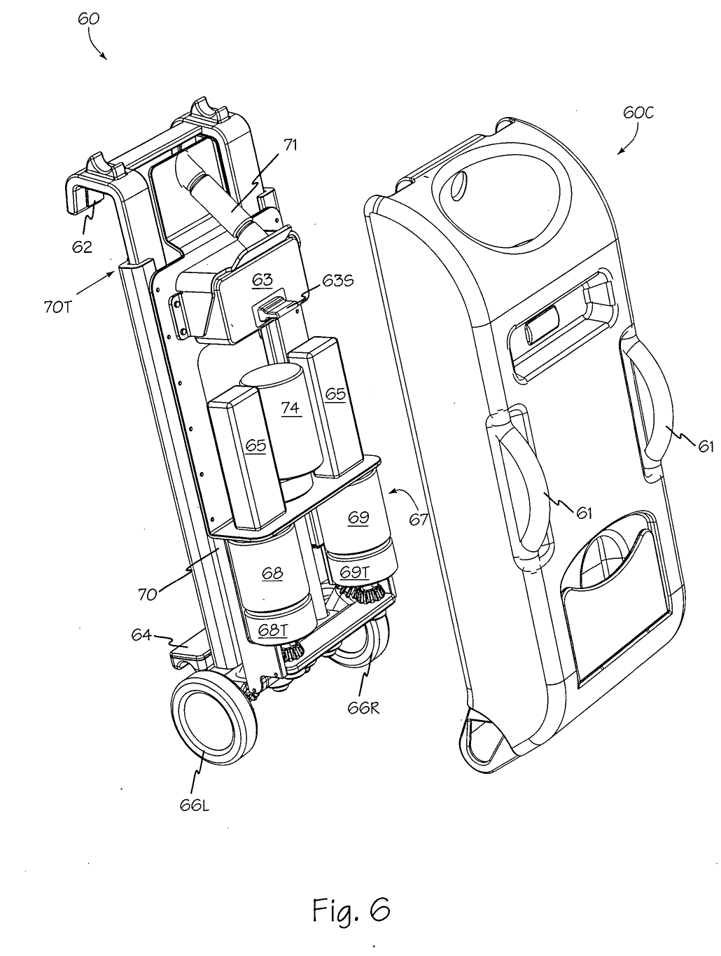

In FIG. 6 container driver 60 is illustrated with cover 60C removed to expose chassis 70 and drive elements 67. One or more batteries such as batteries 65 provide portable and rechargeable power to operate one or more drive motors such as motors 68 and 69. Drive motors 68 and 69 are controlled by controller 63 which includes one or more operator controls such as switch 63S and throttle and or directional controller 71. Drive motors 68 and 69 provide motive energy to wheels 66L and 66R through transmissions 68T and 69T respectively. Chassis 70 engages extendible hooks 62 that extend from top edge 70T. Secondary motor 74 may be provided to drive weight transfer paddle 64 and may also be used to extend and retract hooks 62.

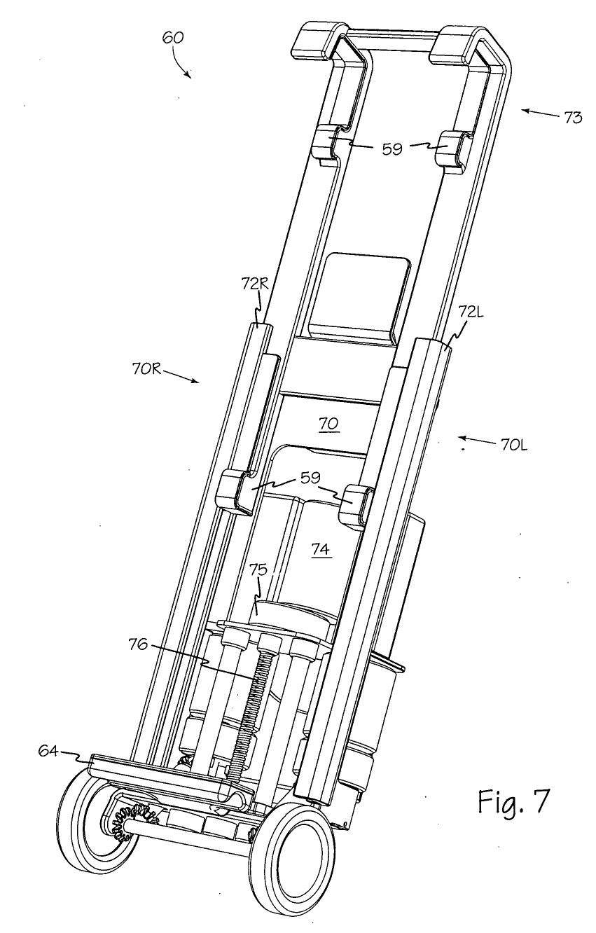

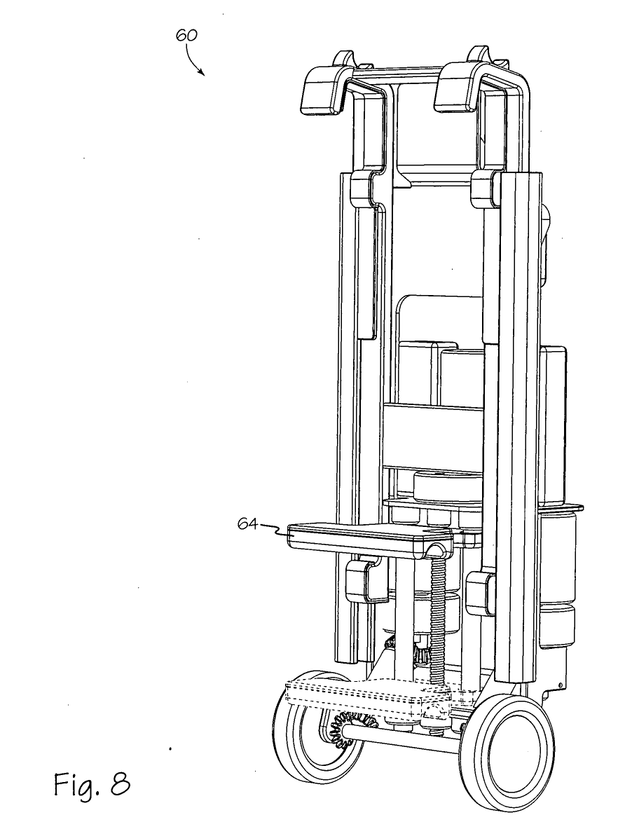

Container driver 60 of FIG. 7 is illustrated with hook assembly 73 extended from chassis 70. Rails or channels 72L and 72R are secured to chassis 70 to slidably engage hook assembly 73 and define right side 70R and left side 70L of chassis 70. One or more spacers 59 may also be included as shown attached to hook assembly 73. As illustrated in FIG. 8, weight transfer paddle is raised and lowered under control of controller 63 by motor 74 transmitting motive power through any suitable gear mechanism such as transmission 75 and threaded drive 76.

In operation, as illustrated in FIG. 4 and FIG. 5, container driver 60 is rolled up to the side of a container such as container 12 and hooks 62 are extended to engage rim 12R. The container driver is oriented to bring the bottom of the container driver into contact with the bottom of the container. Weight transfer paddle is raised beneath container 12 until a portion of the weight of the container is borne by container driver 60, this imparts a significant traction advantage to container driver 60. In this configuration the operator using one or more controls of container driver 60 such as throttle and or directional control may move container driver 60 and engaged container 12 using the motive energy of container driver 60.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A container driver comprising:
a generally planar chassis having a front side and a back side, and a top edge, a bottom edge, a right edge and a left edge;
hook means slidably extending from the top edge of the chassis for engaging the rim of a container to be moved;
two drive wheels rotatably secured along the bottom edge of the chassis;
two drive motors secured to the chassis, each drive motor providing motive energy a drive wheel;
one or more operator controls transforming operator input into speed and direction signals;
a control assembly receiving the speed and direction signals and providing motor control signals to the two drive motors according to the speed and direction signals;
weight transfer means secured to the chassis for transferring weight from a container to be moved to the two drive wheels through the chassis.

2. The container driver of claim 1 further comprising:
extension means for powered extension and retraction the hook means under operator control;

3. A method for moving a four wheeled refuse container comprising the steps:
orienting a container driver having two drive wheels adjacent to the approximate center of a side of a four wheeled refuse container;
extending a hook means from the top of the container driver to engage a rim of the refuse container;
engaging the rim of the refuse container with the hook means;
manipulating operator controls to drive a weight transfer paddle from a bottom edge of the container driver up under a bottom edge of the refuse container to transfer a portion of the weight of the refuse container to the container driver;
manipulating operator controls to supply motive energy to drive wheels of the container driver to move the container driver and the engaged refuse container.

4. The method of claim 3 wherein the step of manipulating operator controls to supply motive energy further comprises:
manipulating operator controls to independently supply motive energy to each of the two drive wheels of the container driver to move the container driver and the engaged refuse container.

5. The method of claim 3 wherein the step of extending a hook means further comprises:
manipulating operator controls to apply power to extend a hook means upwardly from the top of the container driver past a rim of the refuse container;
manipulating operator controls to apply power to retract the hook means to engage the rim of the refuse container.
